(19) United States
(12) Patent Application Publication
(10) Pub. No.: US 2026/0357942 A1
(43) Pub. Date: Nov. 12, 2026

(54) FLEXIBLE INSULATION SLEEVE

(71) Applicant: Cooper-Standard Automotive Inc., Northville, MI (US)

(72) Inventors: Brian J. Cardwell, Ypsilanti, MI (US); Jesse Richard Whipkey, Oscoda, MI (US)

(73) Assignee: Cooper-Standard Automotive Inc., Northville, MI (US)

(21) Appl. No.: 19/205,987

(22) Filed: May 12, 2025

(51) Int. Cl. F16L 59/02; F16L 59/153

(52) U.S. Cl. CPC F16L 59/022; F16L 59/153

(57) ABSTRACT

The disclosure relates to a flexible insulation sleeve having an elongate cylinder defining a central passageway along a longitudinal axis of the cylinder, a helical cut through the cylinder around the longitudinal axis defines a half-included angle β with the longitudinal axis providing a conical-shaped spiraling wall at the helical cut which covers the central passageway at a bend in the insulation sleeve.

### FIELD

The field is related to conduits such as tubes, pipes and hoses used in vehicles having internal combustion engines or electrical vehicles powered by batteries, and more particularly to an insulation sleeve to reduce heat loss or gain in the fluids being conveyed through said conduits and that is easy to install and is sufficiently flexible to be go around corners while maintaining its insulation properties.

### BACKGROUND

Flexible tubing or conduit is commonly used in vehicles such as automobiles, trucks, construction and excavation machines, and others to convey fluids. Fluids flowing through conduit are subject to heat loss or heat gain with exposure to ambient conditions. Thus, it is desirable to insulate the conduit from exposure to the ambient conditions to reduce heat exchange. As the flexible tubing is commonly routed through twisting and turning routes, it is important that the insulation material be sufficiently flexible to adhere to the conduit while maintaining its insulating properties. It is also important for the insulation material to be easy to install and preferably light weight. Conduit can also be used to bundle and protect wires, cables, and hoses needed to operate, for example, an engine, a battery, and power equipment associated with the vehicle. The tubing or conduit while in use is subject to physical damage, abrasion, vibration, and environmental factors like heat and cold that may damage or degrade the conduit and/or its contents. Accordingly, it is desirable to produce a product to insulate the conduit from such environmental factors in an inexpensive, easy-to-install, and light-weight product.

### SUMMARY

This disclosure relates to a flexible insulation sleeve comprising an elongate cylinder defining a central passageway along a longitudinal axis of the cylinder, a helical cut through the cylinder around the longitudinal axis defining a half-included angle β with the longitudinal axis to provide a conical spiral.

This disclosure also relates to a flexible insulation sleeve comprising an elongate cylinder having an annular wall, the wall defining a central passageway with a longitudinal axis, a helical cut through the wall at a half-included angle β to the longitudinal axis defining a conical-shaped spiraling wall at the helical cut which covers the central passageway at a bend in the insulation sleeve.

This disclosure also relates to an insulation tube assembly comprising a tube having a wall defining a lumen; and a flexible insulation sleeve having an elongate cylindrical wall defining a central passageway along a longitudinal axis enveloping a portion of the tube and a helical cut through the wall at a half-included angle β to the longitudinal axis.

### BRIEF DESCRIPTION OF THE DRAWINGS

FIG. 1 is a top plan view of a flexible insulation sleeve of the present invention.

FIG. 2 is a side perspective view of a flexible insulation sleeve with a conical-shaped spiraling wall created by a compound cut in the sleeve.

FIG. 3 is a perspective view of an assembly of the insulation sleeve enveloping a section of a conduit.

FIG. 4 is a diagrammatic view of a helical cut angle.

FIG. 5 is a diagrammatic view of a conical cut angle.

FIG. 6 is a view in the XY plane of a tool for forming the helical cut of the compound cut.

FIG. 7 is a view in the XZ plane of the tool for forming the conical cut of the compound cut.

While the following is described in conjunction with specific embodiments, it will be understood that this description is intended to illustrate and not limit the scope of the preceding description and the appended claims.

### DETAILED DESCRIPTION

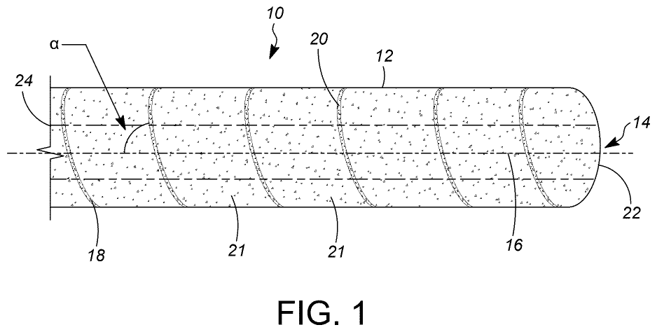

FIG. 1 shows a flexible insulation sleeve 10 of an elongate cylinder comprising an outer wall 12 defining a central passageway 14 with a longitudinal axis 16. A helical cut 18 through the wall at a compound angle defines a conical-shaped spiraling wall 20 with connected segments 21. Preferably, the helical cut 18 extends from a first end 22 to a second end 24 of the sleeve 10.

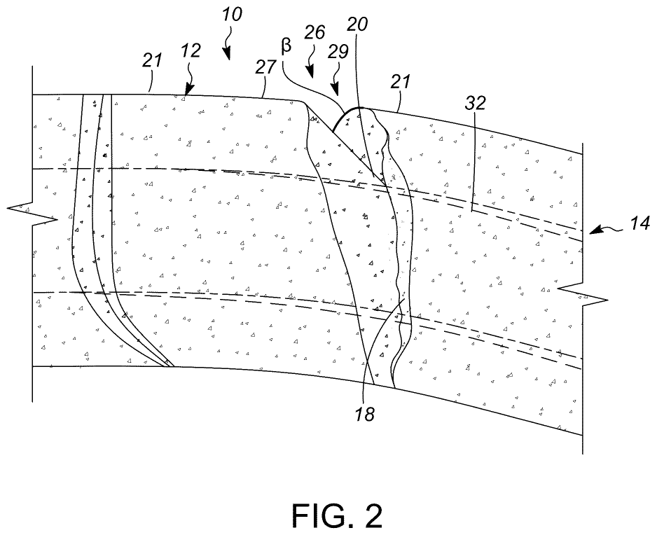

FIG. 2 shows the conical-shaped spiraling wall 20 covers the central passageway 14 at a bend 26 in the outer wall 12 at the helical cut 18 between adjacent segments 21. When the insulation sleeve 10 is bent at bend 26 to conform to a conduit 32 being routed through a turn, the peripheral outer surface 27 of adjacent segments 21 move away from one another during the bending process to create gaps 29. The gaps 29 are spanned by the conical, spiraling wall 25 so that the conduit is still adequately insulated even when the conduit is extending through tight turns.

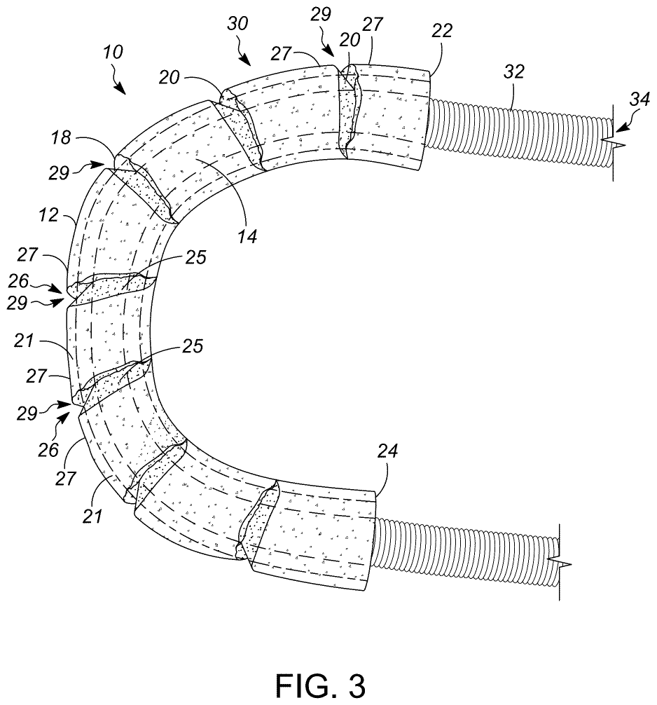

FIG. 3 shows an insulation tube assembly 30 having the insulation sleeve 10 defining the central passageway 14 with the annular wall 12 having the first end 22 and the second end 24 and the helical cut 18 extending therebetween and creating segments 21. The insulation sleeve 10 with a full thickness cut can be wrapped around a conduit 32 to fully envelop a desired length of the conduit and at a desired location along the length of the conduit. The insulation sleeve 10 maintains insulation to the conduit 32 even through bends 26 that form a C-shaped tube assembly 30 and despite the gaps 29 formed in the outer peripheral surface 27.

A helical cut 18 through the full thickness of the insulation sleeve 10 allows for adjusting the length of the insulation sleeve by pulling one end away from the other or by pushing one end toward the other and still provide overlapping protection of the conduit 32 despite the formation of gaps 29 in the outer peripheral surface 27. It is also contemplated that the helical cut 18 can be made partially, but not all the way, through the thickness of the sleeve 10. For partial thickness cuts, the conduit 32 must be inserted into the central passageway 14 at one end of the sleeve and the conduit and/or sleeve can be pushed or pulled until the conduit is covered in a desired length and location.

The conduit 32 has an internal lumen 34 for conveying fluids. The conduit can also be used to bundle and protect wires, cables, and hoses. The conduit 32 can be a hose, a pipe, or a tube and can be rigid or flexible. The conduit 32 can extend along a straight path or extend along a curved, twisting, and/or tortuous path. The conduit 32 can be convoluted as shown or have a smooth outer profile. The insulation sleeve is sufficiently flexible to conform to the conduit 32 and provide protection even when the conduit 32 is bent into a C-shape. The insulation sleeve provides protection from heat exchange with the ambient environment to reduce heat loss or heat gain in the fluid being conveyed through the conduit. The insulation sleeve also provides protection from physical damage, abrasion, vibration, and environmental factors like heat and cold that may damage or degrade the wires, cables and hoses contained in the conduit 32.

The tube assembly 30 is well suited for use, for example, in a motorized vehicle. Fluid conduits are used to connect components and place them in fluid communication. Wiring conduits are for placing components in electrical communication. The components include, for example, engine cooling systems, battery cooling systems, lighting, turn signals, air conditioning, ignition systems, steering, braking, lane departure warning systems, batteries, radiators, wind shield wipers, wind shield wiper fluid containers, and numerous others. It is common for such conduits 32 to be routed along twisting, turning, and tortuous paths. During vehicle operation, the vehicular environment can be one of extremes in terms of temperature, humidity, and vibration. The air can also be polluted with caustic and corrosive chemicals that pose a danger to unprotected conduits. The insulation sleeve 10 protects the conduit 32 under such harsh conditions and can obviate costly repairs caused by these conditions.

The insulation sleeve 10 may be made from a polymeric material and preferably a foamed polymeric material, and even more preferably a closed-cell foamed polymeric material. Suitable polymeric materials include polyolefins, polyethylene, ethylene vinyl acetate, polyurethane, thermosetting rubbers, ethylene propylene diene monomer (EPDM), neoprene, silicone and other material well known to those of ordinary skill in the art. Suitable polyethylene polymers include homopolymers of ethylene and copolymers of ethylene with alpha-olefins having from 3 to 8 carbons. Suitable polyethylene polymers include high-density polyethylene and low-density polyethylene. Preferably, the insulation sleeve has a density smaller than water.

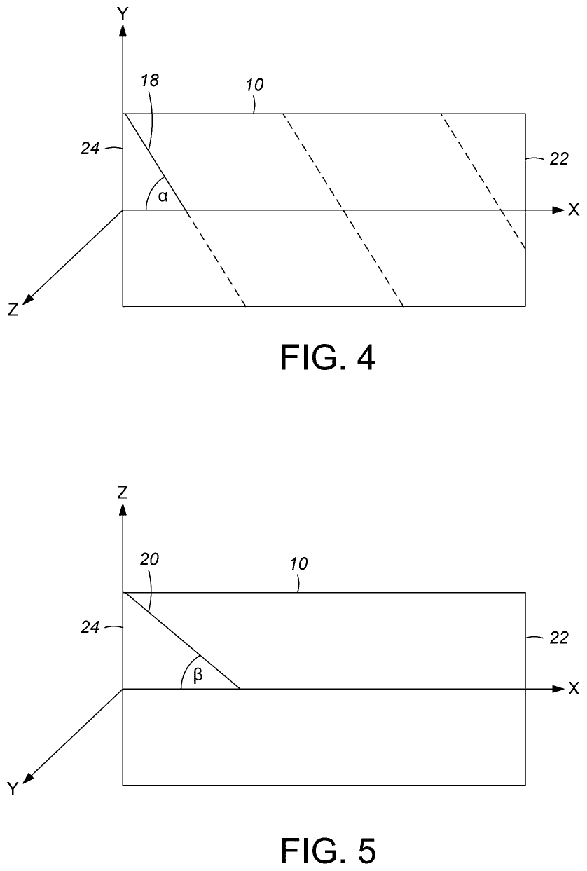

FIGS. 4 and 5 show the compound cut. FIG. 4 shows the angle α of the helical cut in the XY plane. The X-axis aligns with the longitudinal axis 16 of FIG. 1. The angle α is preferably less than 90°, more preferably from about 30° to about 80°, and most preferably from about 30° to about 60°. FIG. 5 shows the angle β of a conical cut in the XZ plane. The angle β is a half-included angle preferably less than 90°, more preferably, from about 30° to about 80°, and most preferably from about 30° to about 60°. The angle α and the angle β can be the same or different from one another.

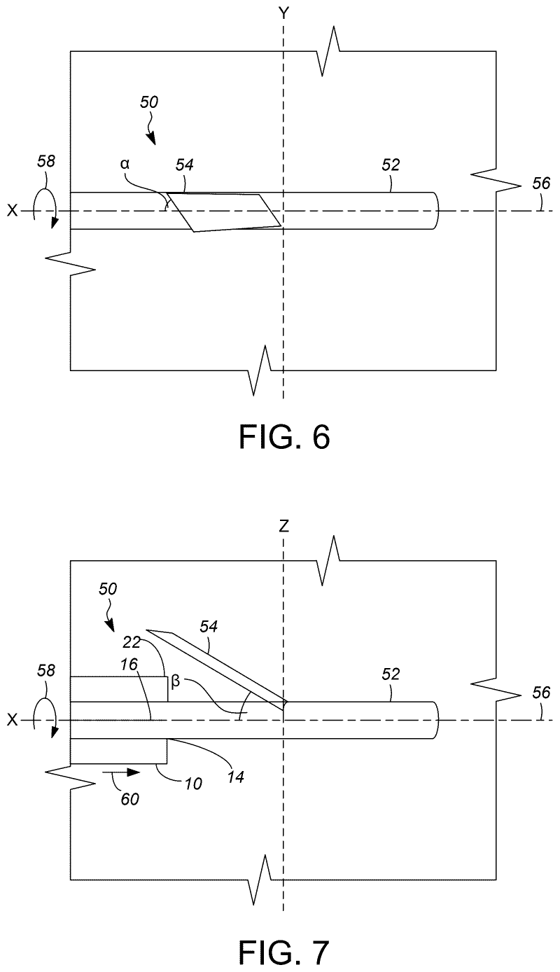

FIGS. 6 and 7 show a tool 50 for forming the compound cut. The tool 50 has a mandrel 52 and a cutting blade 54. The mandrel 52 is cylindrical and dimensioned to fit within the fluid passageway 14 of the insulation sleeve. The cutting blade 54 is mounted to the mandrel 52. As shown in FIG. 6, the cutting blade 54 forms an angle α in the XY plane with a longitudinal axis 56 of the mandrel which is coincident with the X-axis. The angle α of the cutting blade 54 provides the angle α of the helical cut 18.

As shown in FIG. 7, the cutting blade 54 also forms an angle β with the X axis in the XZ plane. The angle β of the cutting blade 54 provides the angle β of the conical component of the helical cut. The angles α and β can be selected from the same angle ranges set forth above.

To make the compound cut, a sleeve 10 with a fluid passageway 14 is slid in the direction of arrow 60 over the mandrel 52 from the left-hand side as shown in FIG. 7 such that the longitudinal axis 16 of the sleeve is coaxial with the longitudinal axis 56 of the mandrel 52. The mandrel 52 is then rotated about the longitudinal axes in the direction of the arrow 58 while the mandrel is moved along the longitudinal axis from right to left, or the sleeve is moved left to right, or both the mandrel and the sleeve are both moved in opposite directions toward each other until the compound cut is made from the first end 22 to the second end 24 of the sleeve. The rotating cutting blade 54 makes a cut having both a helical component at an angle α and a conical component at angle β.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the present disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

1. A flexible insulation sleeve comprising:
an elongate cylinder defining a central passageway along a longitudinal axis of the cylinder, a helical cut through the cylinder around the longitudinal axis defining a half-included angle β with the longitudinal axis to provide a conical spiral.

2. The insulation sleeve of claim 1 wherein said helical cut defines an angle α in an XY plane where the X axis is defined by the longitudinal axis and the Y axis is perpendicular to the X axis.

3. The insulation sleeve of claim 1 wherein said helical cut extends from a first end of the sleeve to a second end of the sleeve.

4. The insulation sleeve of claim 1 wherein said helical cut provides a conical spiral, said central passageway receives a tube therewithin and said conical spiral covers bends of said tube.

5. The insulation sleeve of claim 1 wherein the wall is a foamed polymeric material.

6. The insulation sleeve of claim 1 wherein the angle α is less than 90°.

7. The insulation sleeve of claim 1 wherein the angle β is less than 90°.

8. The insulation sleeve of claim 1 wherein the angle α is from about 30° to about 80° and the angle β is from about 30° to about 80°.

9. The insulation sleeve of claim 1 wherein the angle α is from about 30° to about 60° and the angle β is from about 30° to about 60°.

10. The insulation sleeve of claim 2 wherein the foamed polymeric material is a polyolefins, polyethylene, ethylene vinyl acetate, polyurethane, thermosetting rubbers, ethylene propylene diene monomer (EPDM), neoprene, and silicone.

11. The insulation sleeve of claim 2 wherein the foamed material is a closed-cell foam.

12. A flexible insulation sleeve comprising:
an elongate cylinder having an annular wall, the wall defining a central passageway with a longitudinal axis, a helical cut through the wall at a half-included angle β to the longitudinal axis defining a conical-shaped spiraling wall at the helical cut which covers the central passageway at a bend in the insulation sleeve.

13. The insulation sleeve of claim 12 wherein said helical cut defines an angle α in an XY plane where the X axis is defined by the longitudinal axis and the Y axis is perpendicular to the X axis.

14. The insulation sleeve of claim 13 wherein the angle α is from about 30° to about 80° and the angle β is from about 30° to about 80°.

15. The insulation sleeve of claim 12 wherein the wall is a foamed polymeric material.

16. An insulation tube assembly comprising:
a tube having a wall defining a lumen; and
a flexible insulation sleeve having an elongate cylindrical wall defining a central passageway along a longitudinal axis enveloping a portion of the tube and a helical cut through the wall at a half-included angle β to the longitudinal axis.

17. The insulation tube assembly of claim 15 wherein the helical cut provides a conical-shaped spiraling wall that covers the tube at a bend in the tube.

18. The insulation sleeve of claim 16 wherein said helical cut defines an angle α in an XY plane where the X axis is defined by the longitudinal axis and the Y axis is perpendicular to the X axis.

19. The insulation tube assembly of claim 18 angle α is from about 30° to about 80° and the angle β is from about 30° to about 80°.

20. The insulation tube assembly of claim 16 wherein the cylindrical wall is of a foamed polymeric material.
